(19) United States
(12) Patent Application Publication
(10) Pub. No.: US 2006/0250037 A1
(43) Pub. Date: Nov. 9, 2006

(54) Electrical machine having a stator that is enclosed in an explosion-proof manner

(75) Inventor: Horst Kümmlee, BERLIN (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESSELLSCHAFT, MUNCHEN (DE)

(21) Appl. No.: 10/558,796

(22) PCT Filed: May 21, 2004
(86) PCT No.: PCT/EP04/05507

§ 371 Date: Nov. 28, 2005

(30) Foreign Application Priority Data
May 30, 2003 (DE) 103 24 680.0

(51) Int. Cl. H02K 1/04; H02K 5/12; H02K 5/10

(52) U.S. Cl. 310/88; 310/86; 310/43

(57) ABSTRACT

The enclosure of the stator of an electric machine for an integrated compressor drive should be improved. To this end, the winding heads (4) of the stator (2) are embedded in a solid structure on which the enclosure (6) is supported. The structure is preferably made of a potting compound (5) in which additives for increasing the thermal conductivity are introduced. A film (6) serving as a chemical barrier is thus supported pressure-resistant in the outer area on the potting compound (5) and in the inner area on the lamination stack (3) of the stator (2). As a result, the need for complex pressure enclosures in the air-gap area can be eliminated.

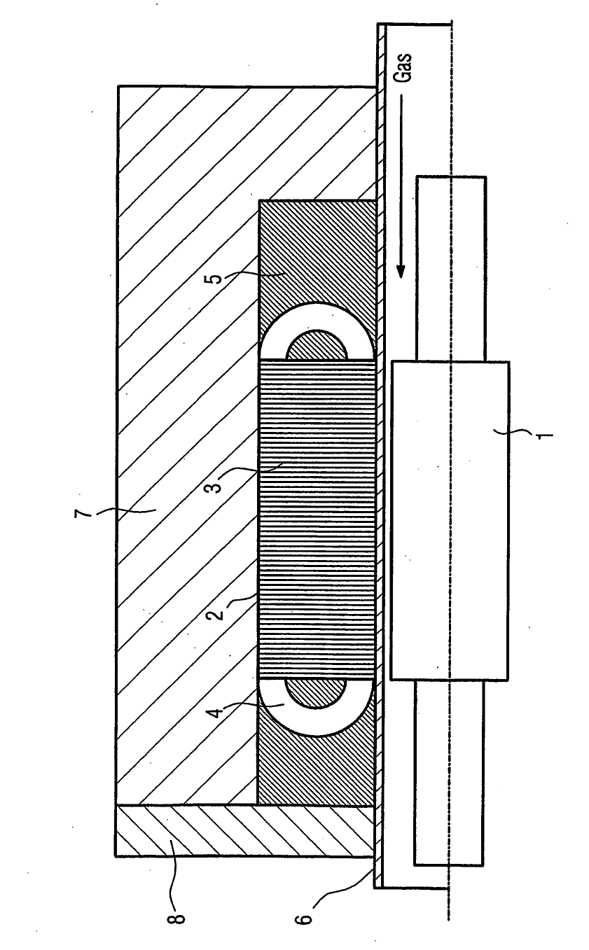

### BACKGROUND OF THE INVENTION

The present invention relates to an electric machine with a stator including winding heads, a rotor arranged inside the stator, and an enclosure for separating the stator from the rotor.

Integrated, electric compression drives are oftentimes used for transport of gases. As a result, the drive itself is located in the gas atmosphere. The drive is hereby exposed to high static and dynamic pressure loads. Furthermore, the medium or gas being conveyed contains, for example when natural gas is involved, aggressive substances which may attack the stator.

The need for self-supporting capability requires a certain material strength. As the enclosure is disposed between stator and rotor, the efficiency of the electric machine decreases in dependence on the material selection and the material strength. In addition, the enclosure results in increased losses and heat up. This can render the use of such a pressure-resistant, integrated electric compressor drive impractical.

### SUMMARY OF THE INVENTION

The object of the present invention is thus the provision of an electric machine with pressure-resistant enclosure of the stator and improved efficiency.

This object is attained in accordance with the invention by an electric machine with a stator with winding heads, a rotor arranged inside the stator, and an enclosure for separating the stator from the rotor, with the winding heads of the stator embedded in a solid structure on which the enclosure is supported.

Embedding the winding heads of the stator in a self-supporting structure eliminates the need for a complex pressure enclosure in the air gap zone between stator and rotor. The required installation space in radial direction can thus be reduced by the factor 2 to 3. This gained installation space may be utilized to reduce the effective magnetic air gap of the machine, resulting in a significant improvement of the efficiency of the machine. Furthermore, the very intensive stiffening of the winding head against electromagnetic force effects is significantly simplified and the winding of the electric machine is further fully protected by the self-supporting structure during transport and handling.

Preferably, the self-supporting structure includes a potting compound or powder compound. Such a potting compound may for example comprise of a cast resin which allows easy production of the structure.

The potting compound may contain additives for increasing the thermal conductivity. In this way, the need for complex cooling systems may conceivably be eliminated as the potting compound provides the respective heat removal.

As an alternative or in addition, cooling channels may be integrated in the structure. Cooling by cooling gas or cooling liquid allows better cooling of the electric components in the structure, in particular the winding heads.

Cooling channels may also be integrated in the lamination stack of the stator so as that its heat removal may also be enhanced.

Preferably, the enclosure includes a layer which is chemically stable in the presence of a medium flowing in the rotor region. Thus, chemically aggressive media may be transported through the electric machine, without encountering an attack on the electric machine itself. This layer may further optimized with respect to abrasion. For example, a nickel film is appropriate and can be contained in the enclosure for these purposes.

Suitably, the stator is surrounded by a pressure vessel so that in the event the enclosure becomes leaky the medium under pressure and flowing through the stator can be collected. This meets certain safety aspects and the medium transported by the electric machine cannot escape to the outside.

### BRIEF DESCRIPTION OF THE DRAWING

The present invention will now be described in more detail with reference to the drawing in which the sole FIGURE illustrates a partial cross sectional view of an electric machine according to the invention.

### DETAILED DESCRIPTION OF PREFERRED EMBODIMENTS

The examples described in more detail hereinafter represent preferred embodiments of the present invention.

The drawing shows a simplified cross section of half of an electric machine according to an embodiment of the present invention. The electric machine includes a rotor 1 and a radially overlying stator 2 which is comprised of a lamination stack 3 and winding heads 4. The stator 2 including the winding heads 4 jointly form with the pressure vessel a self-supporting structure which is made with a potting compound 5. The structure ensures a pressure-resistant support of an enclosure or jacket 6. Thus, the enclosure 6 is supported in the entire stator zone, i.e. in particular also in the winding head region, against a medium under pressure in the rotor space. The enclosure 6 is supported in the marginal areas by the potting compound 5 and in midsection by the lamination stack 3.

The medium may involve a gas under high pressure of for example up to 150 bar. Such conditions are encountered in integrated electric compressor drives for transport of natural gas.

Natural gas but also other media which circulate through the electric machine may contain chemically aggressive substances. For this reason, the enclosure 6 is made of a material, which is chemically stable in the presence of these substances, and represents a chemical barrier between rotor and stator.

The medium or gas being conveyed flowing through the space between rotor and stator may further contain particles causing abrasion of the enclosure 6. Therefore, the enclosure 6 should have a layer or respective material which is resistant to abrasion. Suitable here is for example a nickel film.

Besides the support function, the structure should also have a sufficient thermal conductivity for removal of losses from the electric conductors. The potting compound 5 is thus made of a cast resin in which a heat conductive powder is mixed in. In addition, cooing coils, not shown in the drawing, may be placed or cast into the winding head space for water cooling. Also the area of the lamination stack 3 is cooled by incorporation of unillustrated cooing coils. The cooling coils may be made of tubings which are arranged in the area of the slots or in the back of the lamination stack.

For safety reasons, the stator 2 is surrounded by a pressure vessel 7 which is closed by a lid 8. In the event, the enclosure 6 between rotor 1 and stator 2 becomes leaky, the pressure vessel 7 collects the medium or gas under pressure. This prevents escape of the medium to the surroundings in the event of leakage.

1. An electric machine, comprising:
a stator with winding heads,
a rotor disposed inside the stator, and
an enclosure for separating the stator from the rotor, and
a solid structure in which the winding heads of the stator are embedded in a solid structure and on which the enclosure is supported.

2. The electric machine according to of claim 1, wherein the structure includes a potting compound.

3. The electric machine according to of claim 2, wherein the potting compound contains additives for increasing the thermal conductivity.

4. The electric machine of claim 1, wherein the structure is configured to have cooling channels integrated therein.

5. The electric machine of claim 1, wherein the the stator includes a lamination stack having cooling channels integrated therein.

6. The electric machine of claim 1, wherein the enclosure includes an impervious layer which is chemically stable in the presence of a medium flowing in an area of the rotor.

7. The electric machine of claim 1, wherein the enclosure includes a nickel film.

8. The electric machine of claim 1, further comprising a pressure vessel in surrounding relationship to the stator for accumulating a medium under pressure in an area of the rotor, when the enclosure is leaky.

9. The electric machine of claim 1, wherein the structure includes a powder compound.

10. The electric machine of claim 1, wherein the enclosure includes a leakproof plastic film.

11. The electric machine of claim 10, wherein the plastic film is PEEK.
